(19) United States
(12) Patent Application Publication
(10) Pub. No.: US 2015/0380798 A1
(43) Pub. Date: Dec. 31, 2015

(54) COUPLER

(71) Applicant: KABUSHIKI KAISHA TOSHIBA, Tokyo (JP)

(72) Inventor: Hironori NAGASAWA, Yokohama Kanagawa (JP)

(21) Appl. No.: 14/633,871

(22) Filed: Feb. 27, 2015

(30) Foreign Application Priority Data
Jun. 25, 2014 (JP) 2014-130427

(51) Int. Cl. H01P 5/18; H01P 3/08; H01P 5/12; H01P 5/02

(52) U.S. Cl. CPC H01P 5/12; H01P 5/02; H01P 3/08

(57) ABSTRACT

A coupler comprises a multi-layer wiring substrate. A signal transmission line of the coupler has a first line portion extending in a first direction within a first wiring layer of the multi-layer wiring substrate. A branch line of the coupler has a parallel portion that extends along the first direction in parallel with the first line portion. The branch line is connected to the signal transmission line through first and second connection portions in a second wiring layer. A coupling line is disposed in a wiring layer of the multi-layer wiring substrate that is not the first wiring layer. The coupling line is vertically adjacent, via an insulating layer of the multi-layer wiring substrate, to the parallel portion of the branch line.

### CROSS-REFERENCE TO RELATED APPLICATION

This application is based upon and claims the benefit of priority from Japanese Patent Application No. 2014-130427, filed Jun. 25, 2014, the entire contents of which are incorporated herein by reference.

### FIELD

Embodiments described herein relate to a coupler.

### BACKGROUND

To monitor the power of a high-frequency signal propagating through a signal transmission line, a coupler that branches a part of power from the signal transmission line is used.

In a coupler of the related art, a multi-layer wiring substrate may be used, and a coupling line that is electromagnetically coupled with the signal transmission line in a vertical direction orthogonal with respect to signal propagation direction of the signal transmission line is provided, and the power of the coupling line is measured to determine the power of the signal propagating through the signal transmission line.

However, in the coupler having such a structure, it is necessary to have relatively lengthy portions in which the signal transmission line and the coupling line are electromagnetically coupled to each other to sufficiently increase a coupling between the coupling line and the transmission. Thus, there is a problem that coupling loss increases in the signal transmission line due to the presence such a coupler. In addition, there is a problem that a resistance value of the signal transmission line is increased and power loss of the signal transmission line is increased.

### DESCRIPTION OF THE DRAWINGS

FIG. 1A is a plan view of a wiring pattern of a coupler according to a first embodiment.

FIGS. 1B and 1C are cross-sectional views of a structure of a wiring pattern of a coupler according to a first embodiment.

FIG. 2A is a plan view of a wiring pattern of a coupler according to a second embodiment.

FIG. 2B is a cross-sectional views of a structure of a wiring pattern of a coupler according to a second embodiment.

FIG. 2C is a cross-sectional views of a structure of a wiring pattern of a coupler according to a modification of the second embodiment.

FIG. 3A is a plan view of a wiring pattern of a coupler according to a third embodiment.

FIGS. 3B and 3C are cross-sectional views of a structure of a wiring pattern of a coupler according to a third embodiment.

FIGS. 4A and 4B are cross-sectional views of a structure of a wiring pattern of a coupler according to a fourth embodiment.

### DETAILED DESCRIPTION

Exemplary embodiments provide a coupler which limits degradation of signal transmission quality.

In general, according to one embodiment, a coupler comprises a multi-layer wiring substrate. A signal transmission line is formed in the multi-layer wiring substrate to have a first line portion disposed in a first wiring layer of the multi-layer wiring substrate. The first line portion extends along a first direction. A branch line is disposed in the multi-layer wiring substrate and has a parallel portion that extends along the first direction. The branch line also includes a first connection portion and a second connection portion that extend in a direction intersecting the first direction. The intersecting direction may be, but need not be, perpendicular to the first direction. The first and second connection portions are disposed in a second wiring layer of the multi-layer wiring substrate that is not the first wiring layer. A coupling line is disposed in a third wiring layer of the multi-layer wiring substrate that is not the first wiring layer. In some embodiments, the third and second wiring layers maybe the same wiring layer of the multi-layer wiring substrate. The coupling line is adjacent, via an insulating layer of the multi-layer wiring substrate, to the parallel portion of the branch line in a third direction (e.g., stacking direction) that is orthogonal to a plane of the first wiring layer.

In general, according to one embodiment, a coupler includes a multi-layer wiring substrate, a signal transmission line, a branch line, and a coupling line. The multi-layer wiring substrate includes a first layer, a second layer, and a third layer. The signal transmission line is provided on the first layer, and is capable of transmitting a high-frequency signal. The branch line is provided on the second layer, is branched from the signal transmission line between a first portion and a second portion of the signal transmission line to be wired in parallel to the signal transmission line, and of which characteristic impedance is higher than a characteristic impedance of the signal transmission line. The coupling line is provided on the third layer, and is electromagnetically coupled with the branch line.

Hereinafter, exemplary embodiments will be described with reference to the drawings. Moreover, the same reference numerals are given to the same or corresponding portions in the drawings and description thereof is not repeated.

### First Embodiment

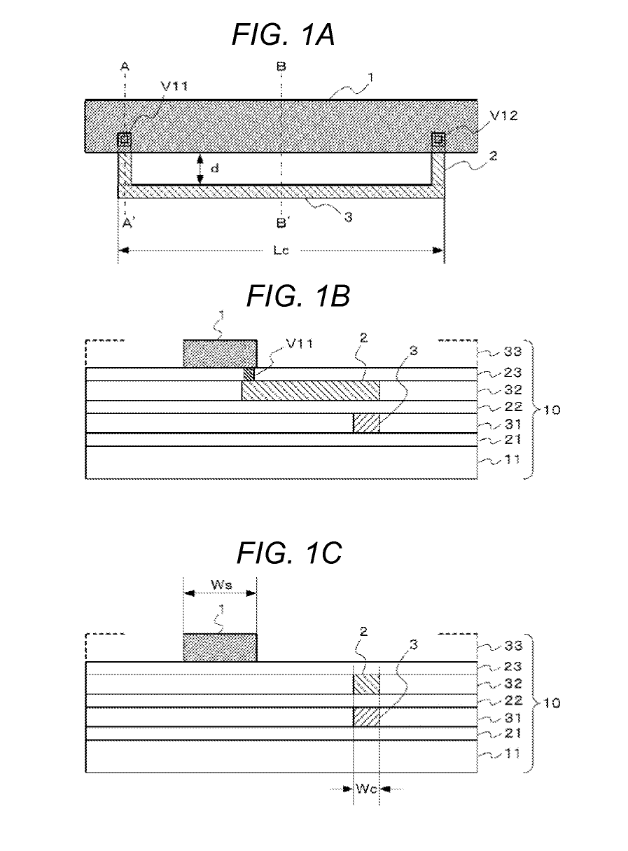

FIG. 1A is a plan view of a wiring pattern illustrating an arrangement example of the wiring pattern of a coupler according to a first embodiment, FIG. 1B is a cross-sectional view of a structure that is taken along line A-A′ of FIG. 1A, and FIG. 1C is a cross-sectional view of the structure that is taken along line B-B′ of FIG. 1A.

As illustrated in FIG. 1A, the coupler according to the first embodiment includes a signal transmission line 1 that is capable of transmitting a high-frequency signal. A branch line 2 that is branched from the signal transmission line 1 through a via V11 disposed in a first portion of the signal transmission line 1 and a via V12 disposed in a second portion of the signal transmission line 1. That is, branch line 2 is connected to signal transmission line 1 by a via 11 proximate to one end of branch line 2 and a via 12 proximate to the other end of branch line 2. The branch line 2 includes a portion running in parallel to the signal propagation direction of the signal transmission line 1. The signal propagation direction would be along the left-right page direction of FIG. 1A and in-out of the page of FIG. 1B/FIG. 1C. A coupling line 3 is electromagnetically coupled with the branch line 2 and extends in parallel with the portion of the branch line 2 running along the signal propagation direction.

As illustrated in FIG. 1B, the coupler is formed on a multi-layer wiring substrate 10. In the embodiment, the multi-layer wiring substrate 10 is configured such that insulating layers 21, 22, and 23 and wiring layers 31, 32, and 33 are alternately laminated on a substrate 11.

As depicted in FIG. 1B, the signal transmission line 1 is formed in the wiring layer 33 (a third wiring) layer and the branch line 2 is formed in the wiring layer 32 (a second wiring layer).

The branch line 2 is connected to the signal transmission line 1 through a via V11 and a via V12, which each connect wiring layer 33 to wiring layer 32 in a vertical (up-down page direction of FIG. 1B) through insulating layer 32. Thus, a portion of signal power transmitted to the signal transmission line 1 is distributed to the branch line 2.

In order to prevent the coupling line 3 from coupling with the signal transmission line 1, the branch line 2 is separated from the signal transmission line 1 by a distance d and is wired parallel to the signal transmission line 1 in the horizontal direction (left-right page direction of FIG. 1A).

Thus, the branch line 2 is first wired in a direction orthogonal to the signal transmission line 1 with the via V11 and the via V12, and then is wired in parallel to the signal transmission line 1. That is, a wiring shape of the branch line 2 has a U shape when viewed along the vertical direction. The length of the branch line 2 in the portion that is wired parallel to the propagation direction of the signal transmission line 1 is Lc.

The coupling line 3 is in the wiring layer 31 (first wiring layer), which is the first wiring layer immediately below the branch line 2. Wiring layer 32 and wiring layer 31 are separated in the vertical direction (stacking direction) by insulating layer 22. The coupling line 3 extends along the propagation direction of the signal transmission line 1 below the portion (the parallel portion) of the branch line 2 extending along the propagation direction. Thus, the coupling line 3 is electromagnetically coupled with the branch line 2. It is thus possible to monitor a magnitude of the signal power of the signal transmission line 1 by observing the signal power of the coupling line 3.

Here, if a length of the wiring of the coupling line 3 is Lc equal to that of the branch line 2, a coupling length of the branch line 2 and the coupling line 3 is represented as Lc.

Since a coupling amount of the branch line 2 and the coupling line 3 is increased as the coupling length Lc is increased, it is possible to make the coupling amount of the branch line 2 and the coupling line 3 be a specifically desired value by adjusting the coupling length Lc.

Furthermore, as illustrated in FIG. 1C, a wiring width Wc of the branch line 2 is narrower than a wiring width Ws of the signal transmission line 1. Thus, a characteristic impedance of the branch line 2 is greater than the characteristic impedance of the signal transmission line 1, with the relative characteristic impedance of these elements varying according to the relative wiring widths (Ws and Wc) of these elements. Therefore, loss of transmission power of the signal transmission line 1 maybe limited even if the branch line 2 is connected.

As depicted in FIG. 1C, the wiring width of the coupling line 3 is also Wc, however the wiring widths of the coupling line 3 and the branch line 2 are not necessarily required equal to each other. However, if the wiring width of the coupling line 3 is narrower than Wc, the coupling between the branch line 2 and the coupling line 3 is in general decreased.

Since the coupling line 3 is electromagnetically coupled with a branch line 2 rather than directly coupled with the signal transmission line 1, the coupling loss in signal transmission line 1 may be reduced.

### Second Embodiment

In the second embodiment, branch line 2 and signal transmission line 1 are formed in the same wiring layer.

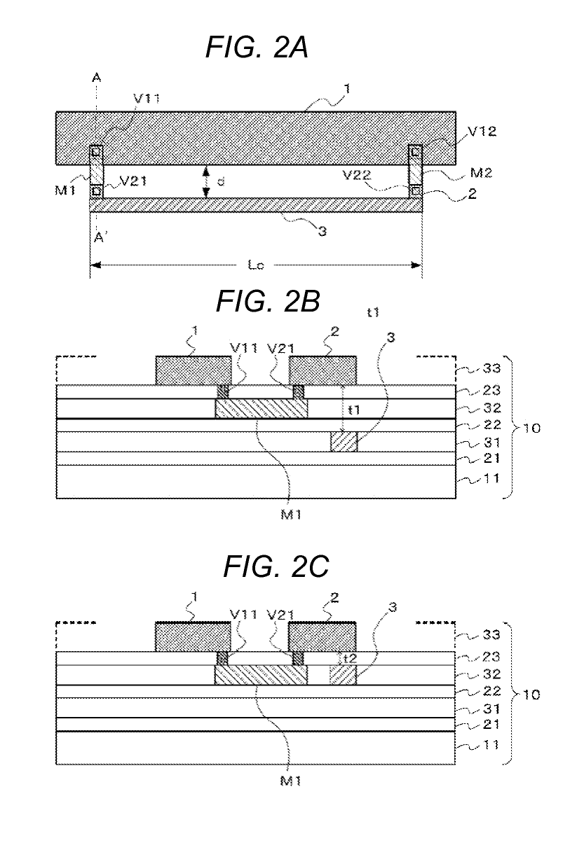

FIG. 2A is a plan view of a wiring pattern illustrating an arrangement example of the wiring pattern of a coupler according to a second embodiment, and FIG. 2B is a cross-sectional view of a structure that is taken along line A-A′ of FIG. 2A.

As illustrated in FIG. 2B, in the embodiment, the branch line 2 is formed in wiring layer 33—that is, the same wiring layer in which the signal transmission line 1 is formed.

As illustrated in FIG. 2A, the branch line 2 is separated from the signal transmission line 1 by a distance d and is wired over a length Lc parallel to the signal transmission line 1.

In order to connect the branch line 2 to the signal transmission line 1, a wiring layer 32 is provided with a connection wire M1 and a connection wire M2 extending in a direction orthogonal to the propagation direction of the signal transmission line 1.

The connection wire M1 is connected to the signal transmission line 1 through a via V11 and is connected to the branch line 2 through a via V21. Similarly, the connection wire M2 is connected to the signal transmission line 1 through a via V12 and is connected to the branch line 2 through a via V22.

In the example illustrated in FIG. 2B, the coupling line 3 is provided in a wiring layer 31 below the branch line 2. In this case, a gap t1 between the branch line 2 and the coupling line 3 is wider than that of the case of the first embodiment. Thus, the coupling amount of the branch line 2 and the coupling line 3 is somewhat decreased.

However, in the modification of the second embodiment illustrated in FIG. 2C, the coupling line 3 is provided in wiring layer 32 immediately below the branch line 2. Thus, a gap t2 between the branch line 2 and the coupling line 3 is narrower than t1 of the example illustrated in FIG. 2B (t2<t1). The coupling amount of the branch line 2 and the coupling line 3 is accordingly increased.

That is, in the second embodiment, it is possible to alter the coupling amount of the branch line 2 and the coupling line 3 by using different wiring layers for forming the coupling line 3.

As described above, according to the second embodiment, it is possible to have the wiring layer forming the coupling line 3 by forming the branch line 2 in the same wiring layer as the signal transmission line 1, and it is possible to change the coupling amount of the branch line 2 and the coupling line 3 without changing an area (width) of the coupler in the horizontal direction in FIG. 2B/FIG. 2C.

### Third Embodiment

In the first and second embodiments, an example of the coupler in which the wiring layer is formed on the multi-layer wiring substrate having three layers is illustrated, but in the third embodiment, an example of the coupler in which the wiring layer is formed on the multi-layer wiring substrate of two layers is illustrated.

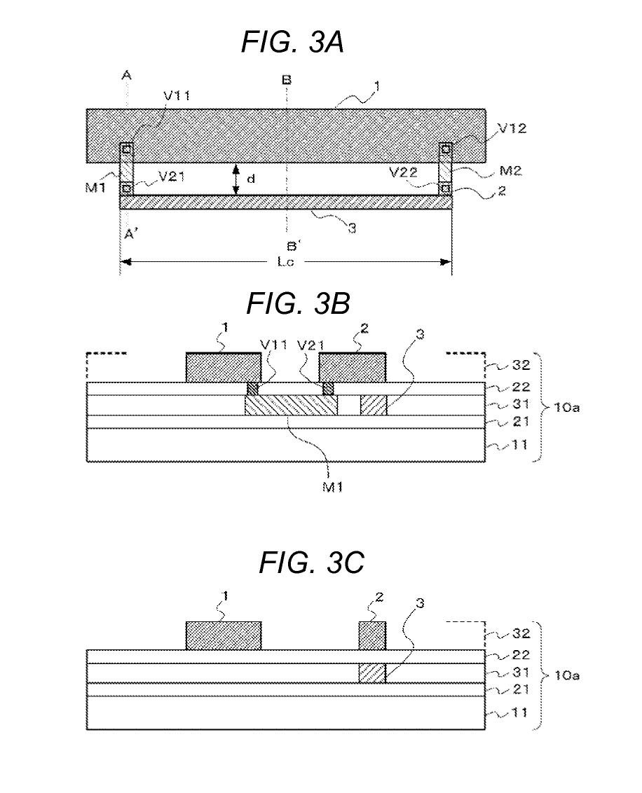

FIG. 3A is a plan view of a wiring pattern illustrating an arrangement example of the wiring pattern of a coupler according to the third embodiment, FIG. 3B is a cross-sectional view of a structure that is taken along line A-A′ of FIG. 3A, and FIG. 3C is a cross-sectional view of the structure that is taken along line B-B′ in FIG. 1A.

As illustrated in FIG. 3B, the coupler according to the embodiment is formed on a multi-layer wiring substrate 10a of two wiring layers. A multi-layer wiring substrate 10a is configured such that insulating layers 21 and 22 and wiring layers 31 and 32 are alternately laminated on a substrate 11.

The basic wiring structure of the third embodiment is the substantially the same as the coupler according to the second embodiment. However, in the third embodiment, since the wiring layer 32 is a wiring layer of the uppermost layer, a signal transmission line 1 and a branch line 2 are formed in the wiring layer 32. A coupling line 3 is formed in the wiring layer 31 immediately below the branch line 2.

According to the third embodiment described above, it is possible to form the coupler on the multi-layer wiring substrate in which the wiring layers are two layers. Since manufacturing costs of the multi-layer wiring substrate is decreased as the number of the wiring layers is decreased, it is possible to decrease the manufacturing costs of the coupler.

### Fourth Embodiment

When a high-frequency signal passes through a signal transmission line, power loss occurs due to resistance of the signal transmission line. In order to decrease the power loss, decreases in the resistance value of the signal transmission line are desirable. The resistance value of the signal transmission line is determined by a resistance of a metal material used for fabricating the signal transmission line and also a width and a thickness of the fabricated signal transmission line. Since the available metal materials and the thicknesses thereof are constrained by manufacturing process, generally, the resistance value of the signal transmission line may be decreased by widening the width of the signal transmission line. However, this causes an increase in an occupied area and reduces the area that is otherwise available for forming the coupler and increases the manufacturing costs.

Thus, in the fourth embodiment, an example of the coupler in which the power loss of the signal transmission line is decreased without increasing the occupied area is illustrated.

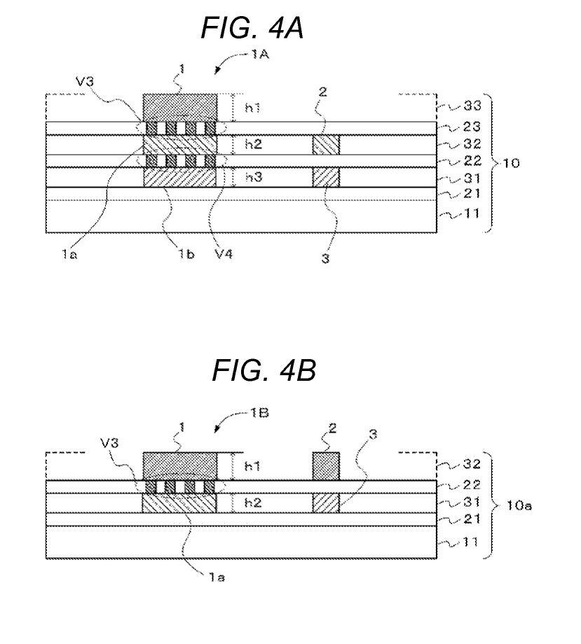

FIG. 4A is a cross-sectional view illustrating an example of a structure of a coupler according to the fourth embodiment formed on a multi-layer wiring substrate 10 in which there are three wiring layers, and FIG. 4B is a cross-sectional view illustrating a modified example of a structure of a coupler according to the fourth embodiment that is formed on a multi-layer wiring substrate 10a having two wiring layers.

The basic wiring structure of the coupler according to the fourth embodiment, as depicted in FIG. 4A, is substantially the same as the coupler according to the first embodiment.

The fourth embodiment is different from the first embodiment in that a signal transmission line 1a and a signal transmission line 1b that are wired parallel to a signal transmission line 1 in the vertical direction are formed immediately below the signal transmission line 1.

The signal transmission line 1a is formed in a wiring layer 32 and the signal transmission line 1b is formed in a wiring layer 31.

The signal transmission line 1a is connected to the signal transmission line 1 through a via group V3 comprising a plurality of vias, and the signal transmission line 1b is connected to the signal transmission line 1a through a via group V4 comprising a plurality of vias.

In the example illustrated in FIG. 4A, the signal transmission line 1, the signal transmission line 1a, and the signal transmission line 1b are connected in the vertical direction to form a complex signal transmission line 1A.

Here, if thicknesses of the wiring of the signal transmission lines 1, 1a, and 1b are respectively represented by h1, h2, and h3, a thickness h of an effective wiring of the signal transmission line 1A is represented by h=h1+h2+h3.

That is, the thickness of the wiring of the signal transmission line 1A is increased as compared to a case of a single layer signal transmission line 1. Therefore, wiring resistance of the signal transmission line 1A is decreased relative to the signal transmission line 1, and the power loss of the signal transmission line 1A is consequently decreased.

In the modified example illustrated in FIG. 4B, the coupler is formed on a multi-layer wiring substrate 10a of wiring two layers. In this case, a basic wiring structure of the embodiment depicted in FIG. 4B is the same as that of the coupler according to the third embodiment.

The example illustrated in FIG. 4B is different from the third embodiment in that the signal transmission line 1a that is wired parallel to the signal transmission line 1 in the vertical direction is formed immediately below the signal transmission line 1.

The signal transmission line 1a is formed in a wiring layer 31 and is connected to the signal transmission line 1 through a via group V3 comprising a plurality of vias.

Thus, in the example illustrated in FIG. 4B, the signal transmission line 1 and the signal transmission line 1a are connected in the vertical direction, whereby a complex signal transmission line 1B is formed. In this case, a thickness h of an effective wiring of the signal transmission line 1B is represented by h=h1+h2.

The thickness of the wiring is smaller than that of the example illustrated in FIG. 4A, but is greater than that of the case of the single layer signal transmission line 1 (e.g., FIG. 1B). Thus, the wiring resistance of the signal transmission line 1B is decreased as compared to that of the single layer of the signal transmission line 1, and the power loss of the signal transmission line 1B decreases.

By forming the wiring (1a and/or 1b) in parallel below the signal transmission line 1 in the vertical direction and connecting these parallel wirings to the signal transmission line 1 in the vertical direction, it is possible to increase the thickness of the effective wiring of the signal transmission line 1. Therefore, it is possible to decrease the power loss of the signal transmission line 1 without increasing the occupied area that is necessary for forming the coupler.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coupler, comprising:
a multi-layer wiring substrate;
a signal transmission line having a first line portion disposed in a first wiring layer of the multi-layer wiring substrate and extending along a first direction;
a branch line disposed in the multi-layer wiring substrate and having a parallel portion that extends along the first direction, a first connection portion, and a second connection portion, the first and second connection portions extending in a second direction intersecting the first direction and disposed in a second wiring layer of the multi-layer wiring substrate that is not the first wiring layer; and
a coupling line disposed in a third wiring layer of the multi-layer wiring substrate that is not the first wiring layer, the coupling line being adjacent, via an insulating layer of the multi-layer wiring substrate, to the parallel portion of the branch line in a third direction that is orthogonal to a plane of the first wiring layer.

2. The coupler of claim 1, wherein the parallel portion of the branch line is in the second wiring layer.

3. The coupler of claim 1, wherein the parallel portion of branch line has a first width in a width direction that is parallel to the first plane and perpendicular to the first direction, and the coupling line has a second width in the width direction that is substantially equal to the first width.

4. The coupler of claim 1, wherein the parallel portion of the branch line is disposed in the first wiring layer.

5. The coupler of claim 4, wherein the second wiring layer is between the first and third wiring layers along the third direction.

6. The coupler of claim 4, wherein the third wiring layer is in a same plane of the multi-layer wiring substrate as the second wiring layer.

7. The coupler of claim 1, wherein the first and second connection portions are each connected to the signal transmission lines through at least one via extending between the first and second wiring layers.

8. The coupler of claim 1, wherein the signal transmission line includes a second line portion extending along the first direction in the second wiring layer, the second line portion being electrically connected to the first line portion through a plurality of vias extending between the first and second wiring layers.

9. The coupler of claim 8, wherein the signal transmission line includes a third line portion extending along the first direction in the third wiring layer, the third line portion being electrical connected to the second line portion through a plurality of vias extending between the second and third wiring layers.

10. The coupler of claim 1, wherein the branch line has a characteristic impedance that is higher than a characteristic impedance of the signal transmission line.

11. A coupler, comprising:
a multi-layer wiring substrate that includes a first wiring layer, a second wiring layer, and a third wiring layer;
a signal transmission line extending along a first direction in the first wiring layer;
a branch line connected to a first portion and a second portion of the signal transmission line that are adjacent to each other along the first direction, the branch line including a parallel portion extending along the first direction in the second wiring layer and having a characteristic impedance that is higher than a characteristic impedance of the signal transmission line; and
a coupling line in the third wiring layer and electromagnetically coupled to the branch line.

12. The coupler according to claim 11, wherein the third wiring layer is below the second wiring layer within the multi-level wiring substrate in a second direction that is perpendicular to the first direction and the coupling line is adjacent to the branch line in the second direction via at least one insulating layer of the multi-layer wiring substrate.

13. The coupler according to claim 11, wherein the second wiring layer is between the first and third wiring layers along the second direction.

14. The coupler according to claim 11, wherein the second layer is the same layer as the third layer.

15. The coupler according to claim 11, wherein the signal transmission line comprises a first line portion extending along the first direction in the first wiring layer and second line portion extending along the first direction in the second wiring layer, and the first and second line portions are electrically connected through a plurality of vias extending between the first and second wiring layers.

16. The coupler according to claim 15, wherein the signal transmission line further comprises a third line portion extending along the first direction in the third wiring layer, and the second and third line portions are electrically connected through a plurality of vias extending between the second and third wiring layers.

17. A coupler, comprising:
a multi-layer wiring substrate including a plurality of wiring layers which are each parallel to a substrate plane and separated from each other by at least one insulating layer in a stacking direction orthogonal to the substrate plane;
a signal transmission line including a first line portion disposed in a first wiring layer of the multi-layer wiring substrate and extending along a first direction that is parallel to the substrate plane;
a branch line disposed in one of the first wiring layer and a second wiring layer of the multi-layer wiring substrate that is below the first wiring layer along the stacking direction, the branch line having a parallel portion extending along the first direction, a first connection portion, and a second connection portion, the first and second connection portions disposed in the second wiring layer and extending in a second direction intersecting the first direction; and
a coupling line disposed in one of the second wiring layer and a third wiring layer of the multi-layer wiring substrate that is below the second wiring layer in the stacking direction, the coupling line being adjacent, via an insulating layer of the multi-layer wiring substrate, to the parallel portion of the branch line in the stacking direction.

18. The coupler of claim 17, wherein the branch line is disposed in the first wiring layer.

19. The coupler of claim 18, wherein the coupling line is disposed in the second wiring layer.

20. The coupler of claim 17, wherein the signal transmission line includes a second line portion disposed in the second wiring layer, the first and second line portions being electrically connected to each other through a plurality of vias extending between the first and second wiring layer.
